(19) United States
(12) Patent Application Publication
(10) Pub. No.: US 2015/0191219 A1
(43) Pub. Date: Jul. 9, 2015

(54) Boat Anchor and Method of Making the Same

(71) Applicant: Geoff Samuels, North Charleston, SC (US)

(72) Inventor: Geoff Samuels, North Charleston, SC (US)

(21) Appl. No.: 14/151,747

(22) Filed: Jan. 9, 2014

(51) Int. Cl. B63B 21/24; B05D 5/00; B05D 1/02

(52) U.S. Cl. CPC B63B 21/24; B05D 1/02; B05D 5/00

(57) ABSTRACT

A lightweight anchor for small boats and a method of making the same. The anchor includes a protective coating. The anchor also includes a release mechanism. The primary release mechanism is provided by flexible tines. The flexible tines make the anchor adaptable to work in various conditions, such as rocky bottoms, reefs, or other similar conditions. The flexible tines also make the anchor easily retrievable. If the tines are bent during retrieval, the tines may be readily returned to their operative configuration.

### BACKGROUND OF THE INVENTION

1. Field of the Invention

The present invention relates to an anchor for small boats which is particularly adapted to be useful for anchoring in a variety of conditions, including rocky bottoms and reefs, and a method of making such an anchor which provides enhanced durability, strength and a longer usable life.

2. Description of Related Art

Known boat anchors generally rely primarily on their weight to serve their intended function. Heavyweight anchors have disadvantages including that they are difficult to retrieve because, among other things, their significant weight requires considerable effort to haul up by hand. Additionally, heavyweight anchors function best in sandy bottoms, but are poorly adapted to rigid bottoms, such as rocky bottoms. A heavyweight anchor is designed to displace sand from the bottom of the body of water in which the boat is to be anchored, as the heavyweight anchor sinks into the sand, displaced sand settles back into place above the anchor until the anchor becomes lodged sufficiently that the boat cannot drift away. Such anchors don't work well in other conditions, such as where there are large rocks on the bottom of the body of water in which the boat is to be anchored, a heavyweight anchor will not displace the rocks and will not be able to sink in and secure the boat as intended. Further, if a heavyweight anchor becomes entangled with a rocky bottom, tree roots or other debris, it can become difficult or even impossible to retrieve the anchor.

There are some lightweight boat anchors known in the art, such as that of U.S. Pat. No. 2,791,982, by L. S. Parry (hereafter “Parry”). Parry solves some of the problems with heavyweight anchors discussed hereinabove. Parry discloses flexible tines 7 that permit the anchor to grab on to a rocky bottom and then to release that grip when sufficient force is applied to bend the tines 7. The tines 7 of Parry are constrained and limited in their range of motion by a lug 6. The lug 6 not only impedes the flexibility of the tines 7, but also forces the tines 7 to always bend at a certain point, this fulcrum point continually places the maximum bending stress on the same part of the tines 7 every time the anchor is used (see, e.g., FIG. 3 and col. 3, lines 8-20 of Parry). Accordingly, it is readily appreciated by one skilled in the art that the tines 7 of Parry will fatigue most rapidly at the single fulcrum point and that failure will occur at the fulcrum point.

The prior art also includes anchors with some form of protective coating, such as those taught by U.S. Pat. No. 5,819,681, Barnes et al. (hereafter, “Barnes”) and U.S. Pat. No. 3,754,524, Locks (hereafter “Locks”). Such prior art anchors are coated by dipping the anchors into the coating material to be applied. This method of applying a protective coating can result in incomplete or insufficient bonding between the anchor and the coating. Further, this method can be time-consuming because it requires multiple repetitions to achieve the desired coating thickness (e.g., as described by Barnes at col. 2, lines 47-50).

### BRIEF SUMMARY OF THE INVENTION

The present invention provides a lightweight anchor that operates by gripping engagement with the bottom surface such that it can be used with many commonly encountered surface conditions. The anchor disclosed herein may be quickly and easily deployed, because it is lightweight the user can lift and throw it with minimal effort. The disclosed anchor is also easily retrieved, even under conditions that would present substantial difficulty with a conventional anchor. The anchor disclosed herein further includes a protective coating which provides greater strength and durability for the anchor, and in particular for the flexible tines.

In contrast with heavyweight anchors most commonly used today, the anchor of the present invention works by hooking into or otherwise engaging the bottom surface of the body of water in which the boat is to be anchored. The anchor of the present invention may therefore be easily retrieved, firstly because it is light in weight, and secondly because its tines will flex under sufficient force to unhook or disengage from the bottom surface. Once the anchor is retrieved, the flexible tines can easily be bent back to their operative configuration to engage with the bottom surface again when the anchor is next deployed. Additionally, the flexible tines are unrestrained in their movement and bending. This allows the tines to freely flex as needed to engage any type of bottom surface. Moreover, the unconstrained bending of the flexible tines allows the bending stress incurred when the tines flex during disengagement from the bottom to be distributed along the length of each tine as it bends, avoiding any fulcrum points so that the bending stress ideally has no concentration point, or at least does not concentrate at the same point repeatedly, which would cause that point to quickly fail under extended use. The protective coating reinforces the flexible tines throughout repeated cycles of bending and re-shaping, which increases the durability and usable life of the anchor.

The ease of retrieval of the disclosed anchor can be enhanced with an additional quick-release feature. In one embodiment, the present invention includes a second attachment point on the bottom end of the main body. The quick-release feature is implemented by rigging the anchor using the second, bottom attachment point as the primary rode attachment point, e.g., by tying a rope or by securely connecting a chain to the bottom attachment point, and the top attachment point is used as a temporary attachment point, e.g., by attaching the rope or chain thereto with a cable tie, also known as a zip tie. When the anchor is deployed, the temporary rode attachment at the top attachment point will be operative. When sufficient force is applied to break the temporary connection at the top attachment point, the anchor will be inverted and disengage from the surface, allowing for quick and easy retrieval of the anchor.

### BRIEF DESCRIPTION OF THE DRAWINGS

FIG. 1 is a front perspective view of an embodiment of the disclosed anchor, illustrating an example of possible lettering which can be included, and with a portion of the protective coating removed for illustration purposes.

FIG. 2 is a rear view of an embodiment of the disclosed anchor including a variety of possible positions within the free range of movement of an illustrated flexible tine.

FIG. 3 is a top-down view of an embodiment of the disclosed anchor.

FIG. 4 is a bottom-up view of an embodiment of the disclosed anchor.

FIG. 5 is a section view of an embodiment of the disclosed anchor taken along line 5-5 in FIG. 3.

### DETAILED DESCRIPTION

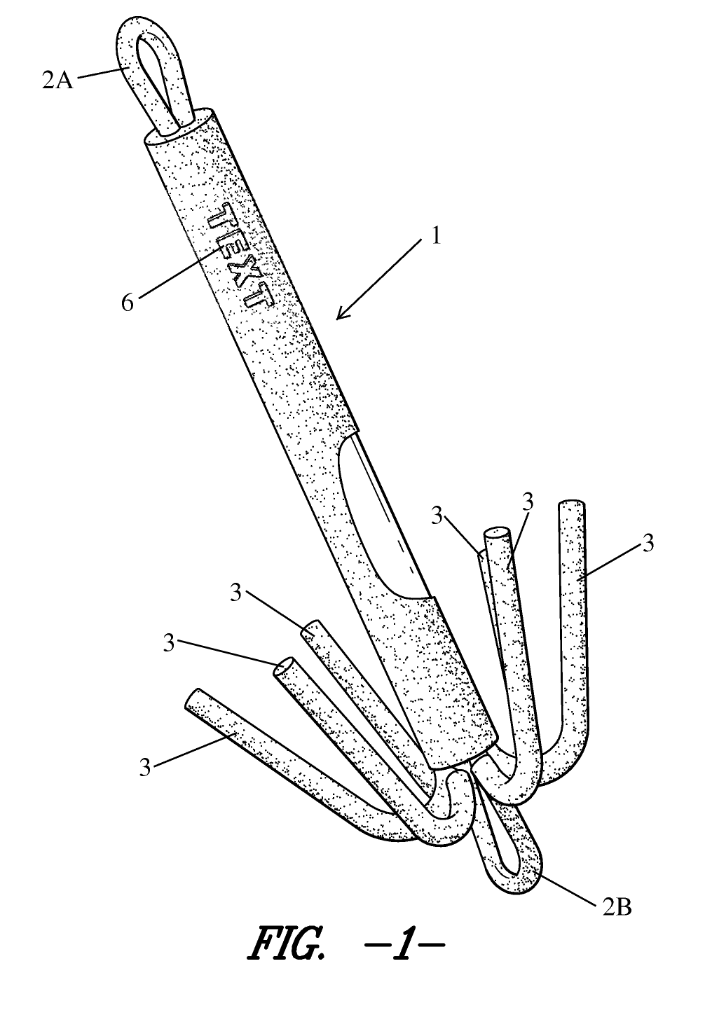

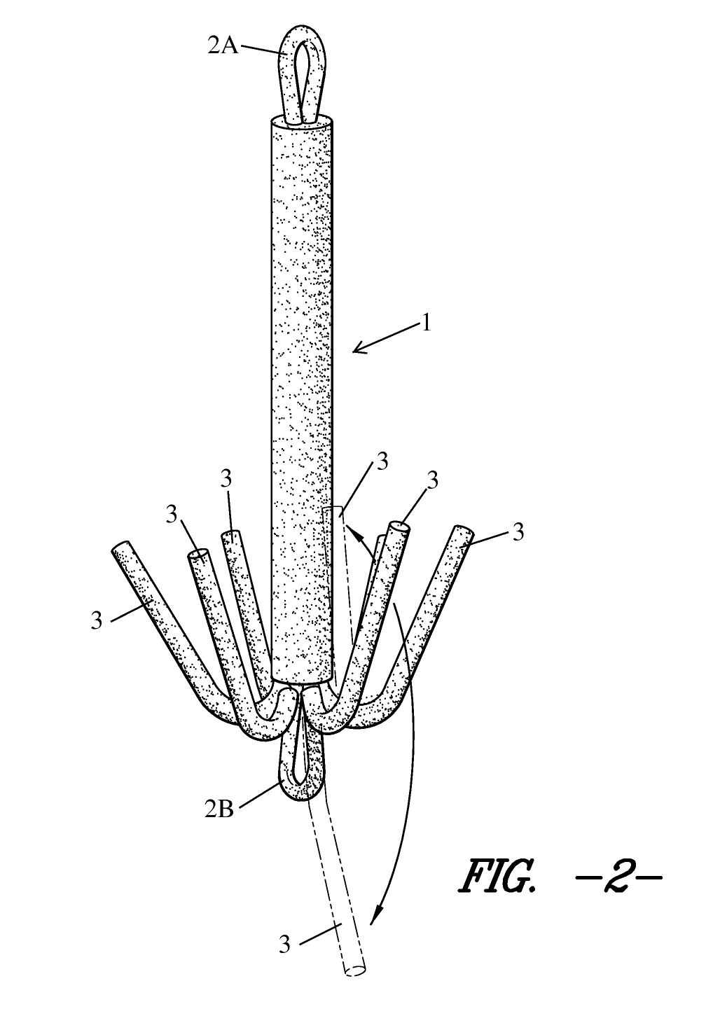

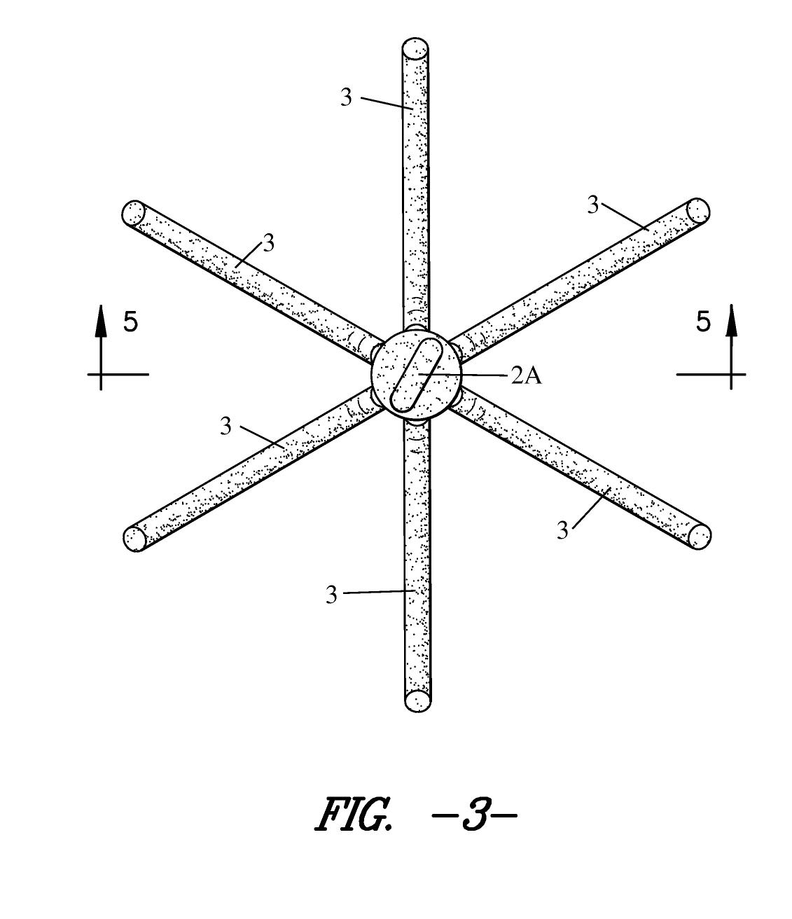

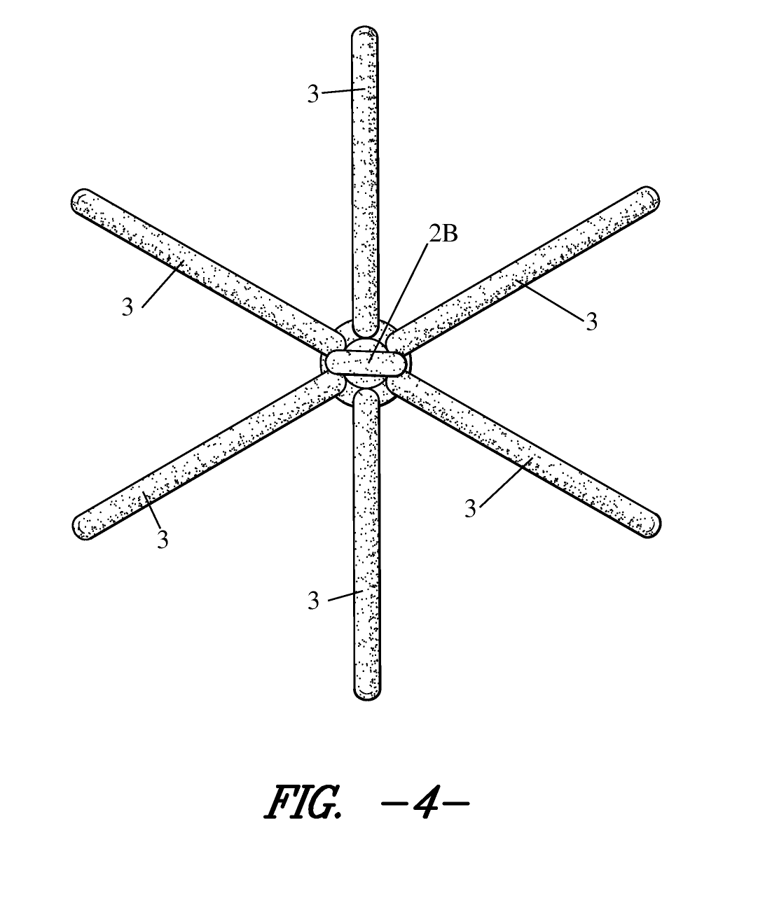

As seen in FIGS. 1-4, The disclosed anchor includes a main body 1 which is formed of a cylindrical surface enclosed by circular faces on each end. A rode attachment point 2A, 2B is provided on one or both ends of the main body 1, on or near one or both endpoints of the longitudinal axis of the main body 1 (i.e., on or near the centerpoint of one or both of the circular end faces). The attachment points 2A, 2B may be provided, e.g., as eye bolts threadedly received by each circular face of the main body, or, as shown in the attached drawings, in the form of a semi-circular arch. The disclosed anchor further includes a plurality of flexible tines 3 attached to one end of the cylindrical surface of the main body 1, the end of the main body 1 where the tines 3 are attached is referred to as the bottom end.

A rode attachment point 2A is provided on or near the top endpoint of the longitudinal axis of the main body 1. A second rode attachment point 2B may optionally be provided on or near the bottom endpoint of the longitudinal axis of the main body. When the top attachment point 2A is the only attachment point provided, it is intended to be used to provide a secure and relatively permanent connection of the rode to the anchor. When a second, bottom attachment point 2B is also provided, it is intended to be used as the primary rode attachment point, e.g., by tying a rope or by securely connecting a chain to the bottom attachment point. Further, when a second, bottom attachment point 2B is provided, the top attachment point 2A is used as a temporary attachment point, e.g., by attaching the rope or chain thereto with a cable tie, also known as a zip tie. When the anchor is deployed, the temporary rode attachment at the top attachment point 2A will be operative. When sufficient force is applied to break the temporary connection at the top attachment point 2A, the anchor will be inverted and disengage from the surface, allowing for quick and easy retrieval of the anchor.

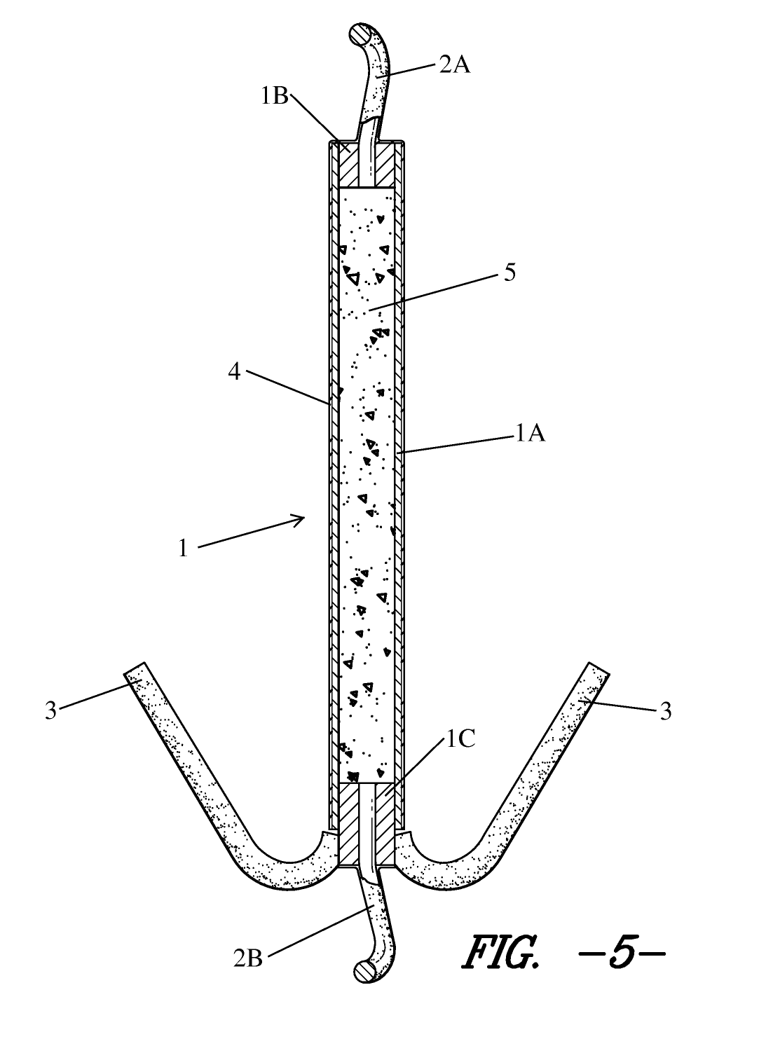

As seen in FIG. 5, the main body 1 is comprised of a tube 1A, enclosed by a top end plug 1B and a bottom end plug 1C. The interior of tube 1A is filled with a heavy material 5, such as concrete as shown in FIG. 5. Tines 3 are preferably attached to main body 1 at the bottom end plug 1C as shown in FIG. 5. However, alternate configurations are contemplated within the scope of the invention. For example, tines 3 can be attached to the tube 1A, in which case the outer edge of bottom end plug 1C may be aligned with the bottom end of tube 1A, in a similar fashion to that illustrated in FIG. 5 for top end plug 1B.

It is preferred that the main body 1, rode attachment point(s) 2A, 2B, and flexible tines 3 be formed of a metallic material. In particular, an aluminum alloy provides desirable characteristics of flexibility and corrosion resistance which are advantageous in this application. The flexible tines 3 are preferably equally spaced around the circumference of the cylindrical surface of the main body 1. In a preferred embodiment, six such tines are provided. In cross-section, the tines 3 are generally shaped like wires, that is, the tines 3 are solid elongated cylinders with a constant diameter. This embodiment provides advantages in ease of manufacture and reduced expense, however, additional configurations of the tines 3 may be considered within the scope of this disclosure, as further discussed hereinbelow. A first portion of each tine 3 is attached to the main body 1 (i.e., is proximal to the main body, and therefore the termination of this portion is described as the proximal end). When in their operative configuration, a second portion of the tine 3 (the terminus of which is referred to as the distal end) is bent back on itself, forming an angle of approximately 45 degrees with respect to the main body 1. When the tines 3 are so arranged, they are in their operative configuration and are capable of gripping engagement with a variety of bottom surfaces.

While a simple wire-like shape for the tines 3 is a preferred embodiment, other shapes may have different advantages and are contemplated within the scope of this invention. Some anchoring conditions may require enhanced grappling engagement. It is contemplated within the scope of this invention to provide tines 3 with barbs on their distal ends for use in such conditions.

The disclosed anchor further includes a protective coating 4. In a preferred embodiment, the protective coating 4 is an elastomeric coating. It is further preferred that the elastomeric coating 4 be a sprayed-on material, for example, one of the LINE-X® type spray-on coatings. Such coatings can be rapidly and effectively applied by spraying with little wasted coating material, in contrast to dipped coatings which require a reservoir of coating material containing far more material than will actually be used to coat the anchor. In particular, a two-part polyurea which is applied by spraying with sufficiently high temperature and high pressure such that it will bond with the substrate to which it is applied has been found advantageous. The elastomeric coating 4 prevents the anchor from scratching the vessel with which the anchor is used. The elastomeric coating 4 further enhances the durability and usable life of the anchor. When the flexible tines 3 bend and are re-shaped, their material undergoes stress and strain, the long-term cumulative effects of these forces will ultimately cause the tines to break. Because the tines 3 of the disclosed anchor are reinforced by the protective coating 4, their resistance to the stress and strain of bending and re-shaping is increased and their working life is extended.

Also as shown in FIG. 1, the disclosed anchor can be customized with text 6. Text can be included by placing raised letters 6 on the main body 1 prior to application of the protective coating 4. The letters 6 may be formed of a polymeric material. When the protective coating 4 is applied, it is applied over the polymeric letters 6 and the metallic main body 1 to effectively bond the letters 6 to the main body 1. Thus, the finished product anchor can include custom text such as the user's name or the name of their boat, among other possibilities.

The protective coating 4 can also provide custom color. The preferred spray-on coating 4 described hereinabove can be provided in black, charcoal, blue, white, red, and green. Custom color and custom text are desirable in that users prefer the unique appearance one or both of these features provide. Further, custom colors are useful in that they can make the anchor easier to locate should it become accidentally detached from the rode while underwater.

While preferred embodiments and example configurations have been shown and described, it is to be understood that various further modifications and additional configurations will be apparent to those skilled in the art. All such modifications and configurations are contemplated as being within the scope of the present invention. The specific embodiments and configurations disclosed are illustrative of the preferred and best modes for practicing the invention as defined by the appended claims, and should not be interpreted as limitations on the scope of the invention as defined by the appended claims. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

I claim:

1. An anchor for water going vessels, which is capable of attachment to the vessel via a rode, said anchor comprising:
a main body,
a first rode attachment point on an end of the main body,
a plurality of flexible tines disposed at an end of the main body other than the end of the main body where the first rode attachment point is located, and
a protective coating covering the main body, the first rode attachment point, and the plurality of flexible tines,
wherein said plurality of flexible tines are disposed as to allow unrestrained bending without a defined fulcrum point.

2. The anchor of claim 1, wherein the main body, first rode attachment point, and plurality of flexible tines are made of a metallic material.

3. The anchor of claim 2, wherein the metallic material is an aluminum alloy.

4. The anchor of claim 1, wherein the protective coating is made of an elastomeric material.

5. The anchor of claim 4, wherein the elastomeric material is a two-part polyurea which is sprayed on with high pressure and temperature such that it will bond to the main body, the first rode attachment point, and the plurality of flexible tines.

6. The anchor of claim 1, wherein the main body comprises a cylindrical surface enclosed by circular faces on each end.

7. The anchor of claim 6, wherein the flexible tines are equally spaced around the circumference of the cylindrical surface of the main body, wherein each flexible tine further comprises a first portion attached to the main body, and a second free portion which foams an angle of approximately 45 degrees with respect to the main body.

8. The anchor of claim 1, further comprising a second rode attachment point on an end of the main body other than the end of the main body where the first rode attachment point is located.

9. The anchor of claim 1, further comprising a set of raised letters between the main body and the protective coating.

10. A method of making an anchor for water going vessels, comprising:
providing an anchor, said anchor comprising a main body, a first rode attachment point on an end the main body, and a plurality of flexible tines disposed at an end of the main body other than the end of the main body where the first rode attachment point is located, wherein said plurality of flexible tines are disposed as to allow unrestrained bending without a defined fulcrum point, and
applying a protective coating to the main body, the first rode attachment point, and the plurality of flexible tines.

11. The method of claim 10, wherein said protective coating is made of an elastomeric material.

12. The method of claim 10, wherein the applying step comprises spraying the protective coating onto the main body, the first rode attachment point, and the plurality of flexible tines.

13. The method of claim 12, wherein the applying step further comprises spraying a two-part polyurea onto the main body, the first rode attachment point, and the plurality of flexible tines at a high temperature and a high pressure sufficient to bond the protective coating to the main body, the first rode attachment point, and the plurality of flexible tines.

14. The method of claim 10, further comprising:
a selection step prior to the applying step, said selection step comprising selecting a color for the protective coating from the group consisting of black, charcoal, blue, white, red, and green, whereby the protective coating applied during the applying step is of the selected color.

15. The method of claim 10, further comprising:
a preparing step prior to the applying step, said preparing step comprising applying a set of raised letters to the main body, and
wherein said applying a protective coating step further includes applying a protective coating to the raised letters.
